(19) United States
(12) Patent Application Publication
(10) Pub. No.: US 2014/0350830 A1
(43) Pub. Date: Nov. 27, 2014

(54) TRAFFIC CONTROL SYSTEM AND METHOD

(71) Applicant: Michel DAVID, Jerusalem (IL)

(72) Inventor: Michel David, Jerusalem (IL)

(21) Appl. No.: 14/367,034

(22) PCT Filed: Dec. 18, 2012
(86) PCT No.: PCT/IB2012/057436

§ 371 Date: Jun. 19, 2014

(30) Foreign Application Priority Data
Dec. 19, 2011 (US) 61577157

(51) Int. Cl. G08G 1/01

(52) U.S. Cl. CPC G08G 1/0145; G08G 1/0141
USPC 701/117

(57) ABSTRACT

A system for facilitating traffic congestion control, comprising traffic related sensors and a system server and database, adapted to receive traffic information from the traffic related sensors and facilitate substantially real time traffic control decision making algorithms in accordance with the traffic information, where the server includes a file with instructions to execute commands to enable execution of the traffic control decisions, the system being operable to receive input information from vehicle control devices and transmit output information to the vehicle control devices in accordance with the traffic control decisions.

### FIELD OF THE INVENTION

The present invention relates in general to systems, methods and devices useful in traffic management and control.

### BACKGROUND OF THE INVENTION

Traffic congestion is a significant problem throughout the world, causing significant damages to personal wealth, national wealth, the environment and to the physical and mental states of billions of people.

Currently, a number of means are used to manage traffic congestion and its effects, including GPS systems, Traffic stopping centers, and Driver rest areas.

It would be highly advantageous to have a system or method that could enable smart traffic management enabling traffic to be optimally managed and drivers to have greater control of traffic conditions.

### SUMMARY OF THE INVENTION

A system for facilitating personalized traffic guidance is provided, to enable optimizing traffic flow, comprising elements described herein.

According to a first embodiment of the invention there is provided a system for facilitating traffic congestion control, comprising traffic related sensors, and a system server and database, adapted to receive traffic information from the traffic related sensors and facilitate substantially real time traffic control decision making algorithms in accordance with the traffic information, wherein said server includes a file with instructions to execute commands to enable execution of said traffic control decisions, the system being operable to receive input information from vehicle control devices and transmit output information to the vehicle control devices in accordance with the traffic control decisions.

The output information may comprise one or more of congestion warning information, congestion prevention information, route change information, and journey timing information.

The database may include a memory having stored thereon participating vehicle data, user preference data, sensor data and traffic control station data.

The input information may comprise driver journey preference information from a vehicle control device, and the system may transmit output information to the vehicle control device in accordance with the traffic control decisions and the driver journey preference information. The output information may comprise one or more of; congestion warning information, congestion prevention information, route change information, and journey timing information.

The driver journey preference information may include, but is not limited to, any of a preferred route, rest stop preferences, preferred journey duration, preferred arrival or departure time, acceptable detours, type of road, and whether toll roads, ferries or other aspects of a possible journey are acceptable or to be avoided.

The system may further comprise one or more traffic control stations and the output information may comprise directions to exit to a traffic control station and to wait there for a specified time.

When the vehicle is at a traffic control station, the output information may comprise guidance to a specific station area.

The input information may comprise one or more of; vehicle speed, vehicle location, driver journey preference information, driver rest stop preference information and driver route preference information.

According to a second embodiment of the invention there is provided a vehicle control device operable to receive driver journey preference information, transmit said driver journey preference information to a traffic congestion control system, receive output information from the traffic congestion control system, and provide said output information to a driver.

The output information may comprise one or more of; congestion warning information, congestion prevention information, route change information, journey timing information, and directions to exit to a traffic control station and to wait there for a specified time.

The vehicle control device may be operable to receive request information and enable efficient access of service and/or product in accordance with the request information.

The vehicle control device may be further operable to transmit input information to the traffic congestion control system, wherein the input information comprises one or more of; vehicle speed, vehicle location, driver rest stop preference information, driver journey preference information and driver route preference information

According to a further embodiment of the invention there is provided a system for advanced traffic management, comprising a communications network adapted to facilitate substantially real time communication between multiple traffic system components, to enable traffic congestion prevention, where *said communications network may include a system server including instructions to execute commands to enable traffic decision making algorithms to optimize traffic congestion prevention, and where said communications network may include a system server including instructions to execute commands to enable user driven requests to be processed, and users to be automatically channeled to locations.

Said automatic channeling may be adapted so as to enable efficient access of service and/or product requests.

Said communications network may include a database component, including a memory having stored thereon user preference data, participating vehicle data, sensor data and traffic control station data.

According to a further embodiment of the invention there is provided a method for facilitating traffic flow enhancement, comprising running one or more files with instructions to execute commands to enable managing and controlling of traffic flow in a traffic management system, as described herein.

According to a further embodiment of the invention there is provided a system for facilitating personalized traffic guidance to enable optimizing traffic flow, comprising elements described herein.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic system diagram depicting components of a traffic management and control system, according to some embodiments;

FIGS. 2A-2E are a series of schematic diagrams of aspects of a traffic control system, according to some embodiments; and

FIG. 3 is a flow diagram indicating a traffic management and control process, according to some embodiments.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “traffic congestion” as used herein refers to traffic jams, traffic slowdowns, traffic accidents, road works generated traffic problems etc., whether in urban areas, inter-urban areas or other areas. The term “traffic control areas” refers to geographical areas, whether dedicated or not dedicated to traffic control, which are adapted to be part of a solution for controlling traffic flow, enabling driver breaks and activities, and facilitating integration with traffic management data systems and networks.

Non-limiting embodiments of the present invention include a system, method, device and/or means for facilitating enhanced traffic control. In some embodiments, systems and methods are provided for enabling real-time traffic management via mobile traffic control devices, collaborating over a traffic control network, to provide traffic control zones.

In accordance with some embodiments, a Traffic Management or Traffic Congestion control or Traffic Flow Control system is provided, that may include a smart traffic control network, devices and infrastructure for enabling traffic control and management, including facilitating synchronized smart travel breaks so as to optimize traffic flow on existing roads.

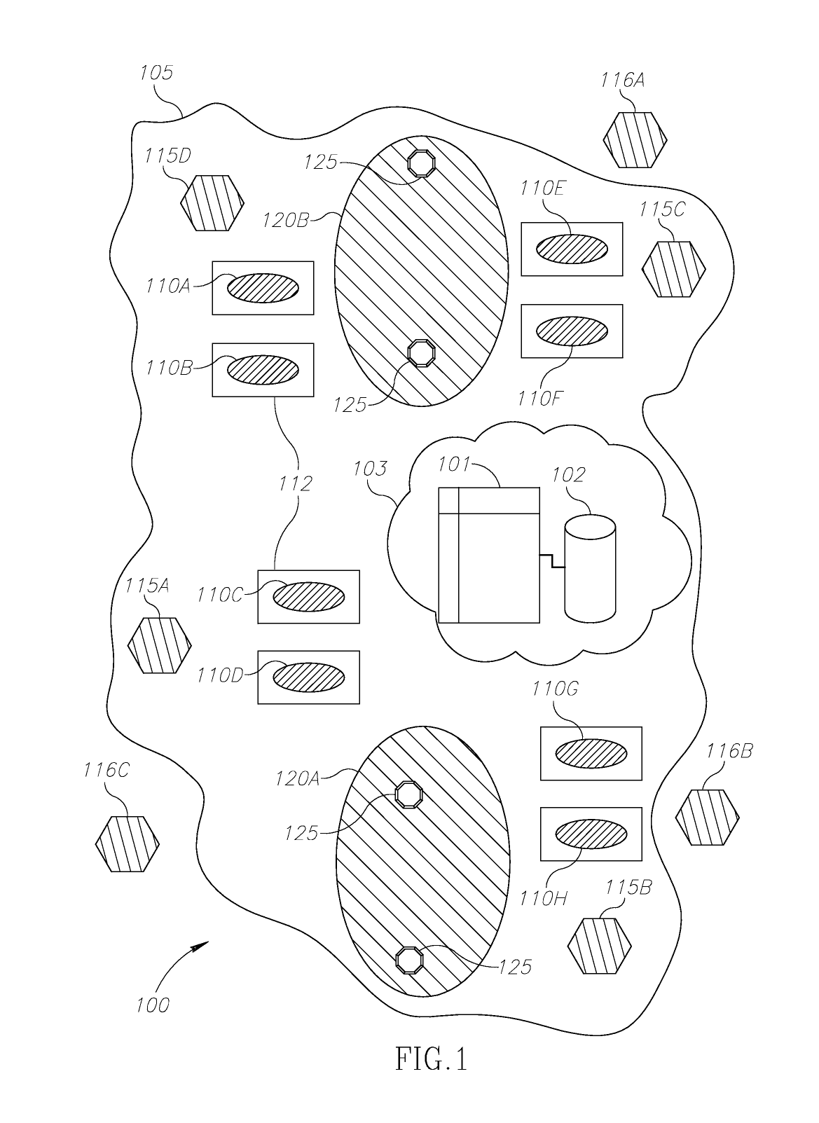

Reference is now made to FIG. 1, which is a schematic system diagram depicting a Traffic management and control system for optimizing traffic management and control by using vehicle based tracking devices and traffic sensors. As can be seen in FIG. 1, the traffic management and control system 100 may include a traffic management and control server 101 and database 102, optionally located in a communications network such as cloud 103, multiple vehicle control devices 110 on multiple vehicles 112, traffic sensors 115 and optionally 116, traffic control areas, locations or stations 120, and a communications network 105 that connects between cloud 103 and the respective devices 110, sensors 115 and 116, and stations 120. Sensors 115 are typically sensors located within a communications network or geographical area where traffic management and control is required, for example, in a congestion-sensitive location. Sensors 116 are typically sensors located externally to a communications network or geographical area where a congestion system is in operation, to provide relevant vehicle related data outside of an area where a congestion system is in operation.

According to some embodiments, traffic management and control server 101 and database 102 may be scalable so as to provide the required data processing, storage, security, reliability etc. to support the traffic control and management system 100, and optionally multiple such systems. Server 101 and database 102 may be cloud based and/or located at one or more local positions so as to provide optimal service cover for system 100. Server 101 and database 102 are to be in communication with vehicle devices 110, sensors 115, sensors 116, stations 120 and other system points, devices, and sources, optionally via communications network 105. In some embodiments, in order to help managing the driver speed and position etc., existing Server Applications may be used, for example, location technology such as WAZE (see www.waze.co.il), Google Maps or other suitable location, mapping, navigation tools or platforms. Vehicle control devices 110 may be integrated into vehicle computing and/or communication systems, may be configured in independent or stand alone devices, and/or may be run as applications or features on mobile computing or communication devices such as smart phones, tablets, wearable or mobile communication, navigation or computing devices etc. Communications network 105 may be an Internet, Intranet, cellular data network, navigational network or other data communications network. Of course, it may be likely that communications network 105 may an integrate two or more communications networks. In some embodiments, system server 101 and database 102, adapted to facilitate substantially real time traffic control decision making algorithms, wherein the server includes at least a file with instructions to execute commands to enable execution of the traffic control decisions.

The system 100 may be operable to receive input information from vehicle devices 110 and transmit output information to the vehicle devices 110 in accordance with the traffic control decisions as explained in more detail below. The input information may comprise driver journey and/or route preference information from a vehicle control device 110, and the system 100 may transmit output information to the vehicle control device 110 in accordance with the traffic control decisions and the driver journey and/or route preference information. It is noted that driver journey and/or route preference information may be for a specific journey or may be for multiple journeys, for example, in accordance with user generic preferences, a user travel schedule etc. The output information may comprise one or more of congestion warning information, congestion prevention information, route change information, and journey timing information. The driver journey or route preference information may include, but is not limited to, any of a preferred route, rest stop preferences, preferred journey duration, preferred arrival or departure time, acceptable detours, type of road, and whether toll roads, ferries or other aspects of a possible journey are acceptable or to be avoided. The output information may comprise directions to exit to a station 120 and to wait there for a specified time and/or a specific event.

According to some embodiments, drivers being diverted to stations 120 should be diverted to specific stations or station areas, such as parking places, gas filling points or points of sale etc., in accordance with their current specified needs. Further, while driving, waiting and/or being active in stations 120, updates or alerts may be delivered at any times to system users, typically via the vehicle control devices 110. In cases where devices 110 are run on mobile communication or computing devices, messages or updates may be delivered to system users inside and outside their vehicles. In some embodiments, dedicated vehicle based control devices may be used, optionally in addition to mobile or user based devices, such as within mobile communication devices applications or software.

In some embodiments, stations 120 may be designed to facilitate pre-ordered or order-on-demand products and services, such that drivers may order services before arrival, via the traffic control system 100, to minimize delays in receiving required products and/or services.

According to some embodiments stations 120 may be equipped with wireless data networks, and optionally with high resolution navigational maps, to enable accurate navigation and reliable data access. According to some embodiments, in order to facilitate effective parking guidance and instant shopping etc., the system may include real time detectors 125, for example, to enable detection substantially in real time of the position of the different cars in the rest, station or parking areas. In one example, image processing based on multiple video cameras on buildings or structures may be used. Alternatively or additionally, WIFI Proximity Mapping may be used, wherein the precise location of each WIFI connected device may be determined. Alternatively or additionally, Car Detection means may be integrated, for example using traffic light sensors such as inductive loop traffic detectors, and/or underground magnetic sensors, designed to identify and communicate accurate and substantially real time data about particular parking space usage. Such real time detectors or tools 125, and other suitable location tools, may enable the system to determine real-time occupancy of parking or rest spots, vehicle details, vehicle license plate numbers etc., substantially in real time.

In accordance with further embodiments, stations 120 may enable, for example, handicapped or disabled users to be automatically channeled to reserved parking areas, such as close to the restrooms and the shopping area. In a further example, users of electric cars or hybrid cars, or cars operating on alternative energy sources, may be automatically channeled to the most accessible and/or available battery loading, battery charging or alternative energy replacement or supplementing stations. Furthermore, users may be directed towards specific reserved parking areas/places near such energy stations. In still further examples, a user with recycling materials may be automatically channeled to a product recycling center. Similarly, a user wanting a specific product or service, for example, a specific food to eat, may enter such request(s) in the system, and may be automatically channeled to the relevant space/area/shop to enable efficient access of such services. Of course, other products and/or services may be likewise accessed using the system. For example, Premium users may be assigned to optimal parking locations etc.

In accordance with some examples, the system may monitor traffic congestion in an area, as well as potential congestion build up in an area. Additionally, the system may monitor particular user positioning and preferences, such that when a user is approaching a congested area or is within a congested area, the system may suggest to the user to drive towards a nearby rest station or alternative route. In some examples the system may inform the driver of the time and/or distance to travel to a rest station, the expected time delay at the station, what may be done at the station, expected time of arrival with or without diverting to the station, benefits for diverting to the station etc. In still further examples, the user may be informed of other benefits, such as amount of fuel, energy or gas to be saved, amount of pollution to be saved, costs of ware/usage of the vehicle, time saved, bonus points or other incentives for cooperation etc.

In further examples, upon request by the system for a driver to enter a station, the system may ask the driver what services/products they require. Optionally before arriving at the station, or upon arrival, the driver may request that one or more service or product providers have services or products ready to provide or deliver upon arrival of the driver. For example, a driver may use provide voice instructions or other data entry to instruct the system that he/she requires 20 liters of gas, a cup of coffee, a newspaper and a takeout lunch, a 6 pack of water and a tent for 4, based on the availability of these products or services at the relevant rest area. In the above case, the system will send the driver to an optimal parking spot to access their needs, or may calculate the optimal path (navigation guidance) to take to acquire the required items with optimal efficiency. In some examples, the system may provide time predictions for each element required, or may enable the user to fill up with gas while the purchased goods are delivered to the car while the driver is filling up with gas. In still further embodiments the required products/services may be paid for by the driver upon ordering, thereby avoiding point of sale payments, which are typically time consuming and a hassle for both the purchaser and the sales provider. In further examples, the driver may be able to request a battery charger or battery purchase/change, vehicle equipment, vehicle maintenance, car wash etc. In further examples, the driver may be able to book/enjoy a session in an exercise room, treatment center, entertainment or any other services or products, preferably in accordance with the planned time delay in the rest station.

According to some embodiments, vehicle control applications or devices 110 may be wireless communication and/or computing devices, optionally being dedicated devices, or being software or applications integrated into mobile phones, computing devices, and/or integrated into vehicle computer or navigational systems. For example, devices 110 may be applications or software that are compatible with a variety of smart phones, mobile phones, tablet or laptops, navigation devices, vehicle computer systems, and other computing or communication devices or systems, such that these devices or systems may function as vehicle control systems. In some examples devices 110 may be integrated into vehicle computing systems such as NASCAR etc. Devices 110 may be equipped with a microphone and voice recognition software, typically adapted to receive voice based commands and/or touch entry commands, so as to ease information entry in accordance with required safety standards. So to, devices 110 may be equipped with text to speech engines to enable speaking of commands, instructions and updates to drivers, in place or in addition to textual based data. In some examples devices 110 may be equipped with data encryption means, such as 128 bit SSL or greater, to ensure necessary data security. In some examples devices 110 may integrate GPS or other positioning technologies. In some examples devices 110 may integrate or be coupled to a subscriber identification module (SIM) that may securely store the service-subscriber key (IMSI) used to identify a subscriber on mobile telephony devices. Such a SIM may further include a unique serial number (ICCID), internationally unique number of the mobile user (IMSI), security authentication and ciphering information, temporary information related to the local network, a list of the services the user has access to, passwords for usual use and for unlocking etc. In still further embodiment vehicle devices 110 may be per-configured with payment means, such as credit cards, such that services purchased may be added to a driver's account automatically, in accordance with per-arranged payment verification means. In some examples, payment means may be re-chargeable smart cards which may be charged with money limits for spending, and enabling tracking of expenditures, tracking of driver purchases, system usage etc.

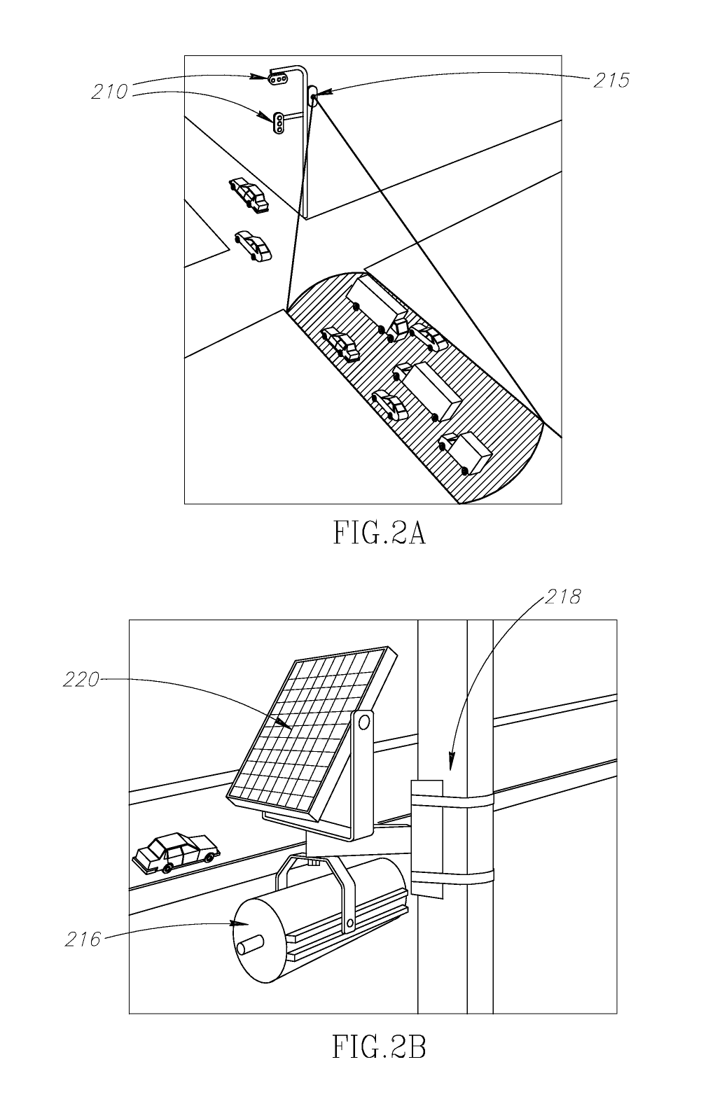

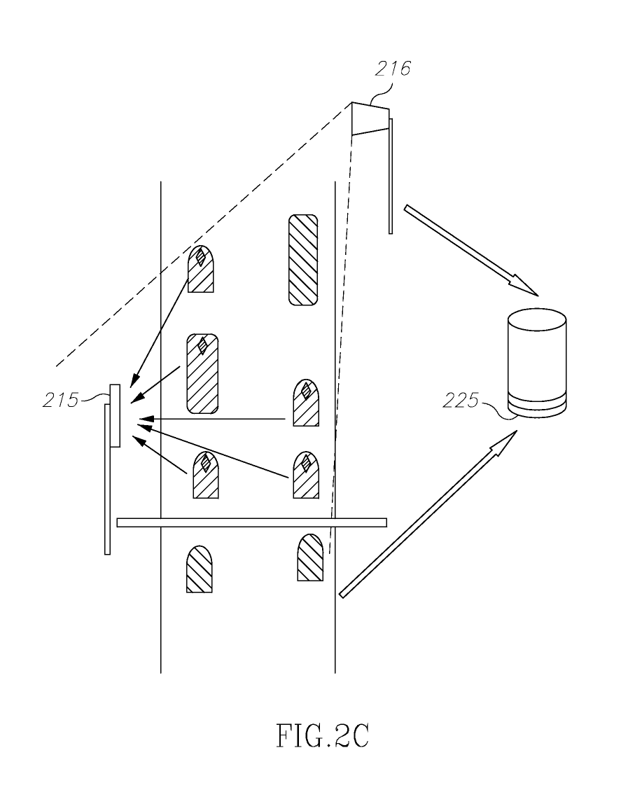

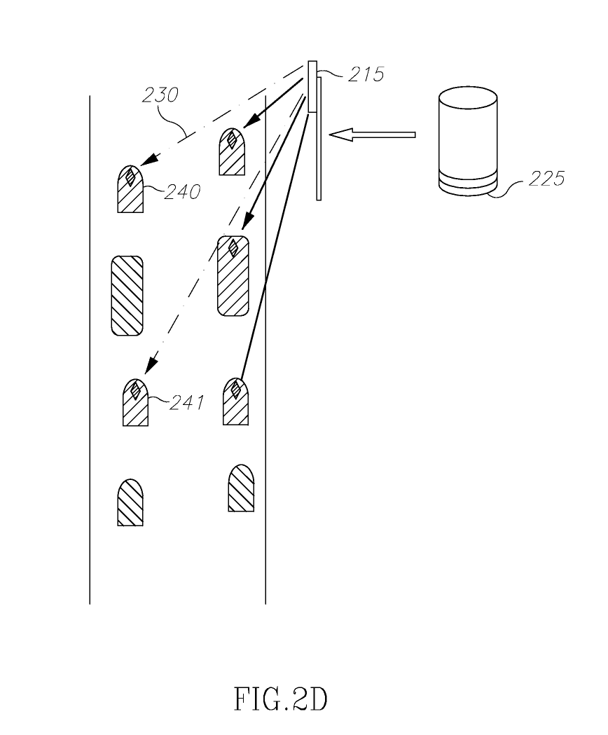

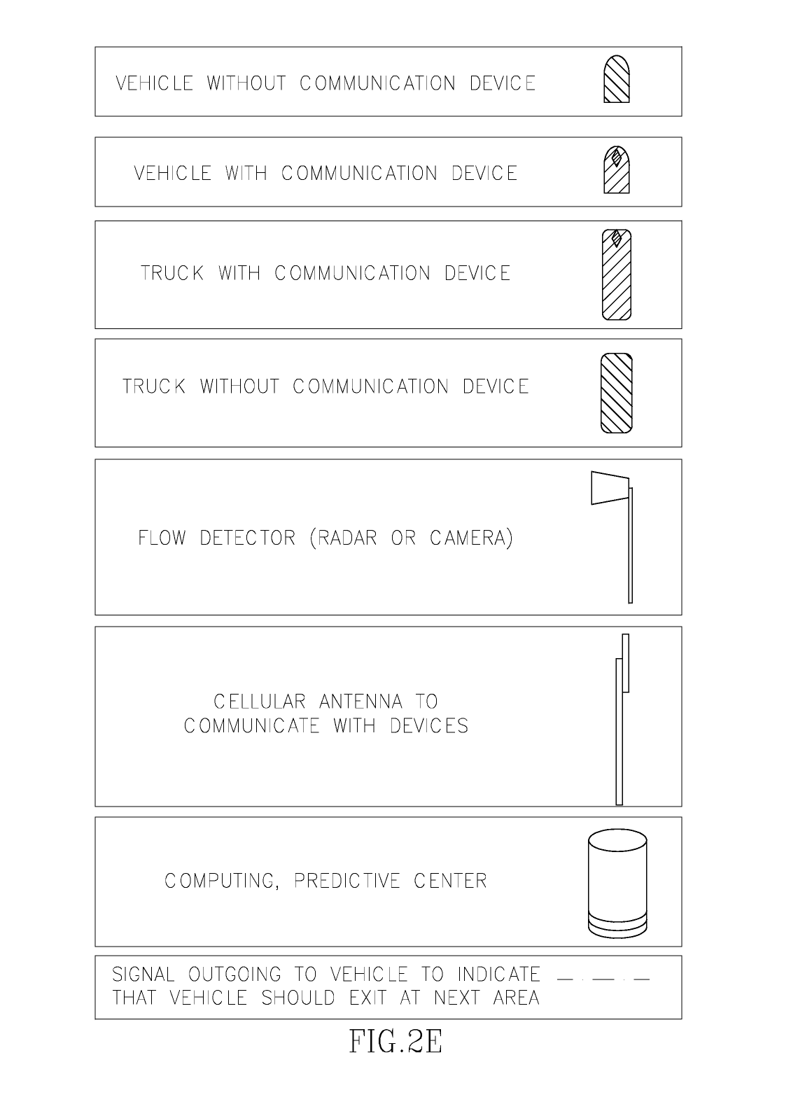

Reference is now made to FIGS. 2A-2E, which illustrate examples of traffic sensor devices 115 or 116 and their operations with the traffic management and control system 100. In some cases sensors 115 and/or 116 may be existing traffic or road sensors, or may even include alternative sensors used by security or safety authorities, businesses or other entities to monitor or track traffic. Traffic sensors may be positioned optimally to monitor and/or track vehicles and/or other congestion related factors. For example, sensors may be placed on street lights, buildings or other locations where height may be utilized to provide a perspective or range of operation. In other examples, sensors may be placed on traffic lights, bridges, intersections, street signs, security vehicles, road barriers or any other locations where it may be efficient to place them. According to some embodiments, traffic sensors may provide traffic congestion or flow data, such as number of vehicles traveling on a given road, average speed of vehicles on a given stretch of road etc. In further examples, traffic sensors may include sensors for a wide range or variety of traffic, vehicle, road and environmental (e.g., weather, light conditions, wetness etc.) conditions, to generate useful traffic related data from the sensors. In this way, sensors may help enable traffic control and management system 100 to execute enhanced decision making based on real time or close to real time traffic conditions, or predictions for traffic conditions. For example, sensors may help identify congestion, road works, accidents, obstacles, traffic flow rates etc. throughout a region being managed. This may enable substantially live traffic data feeds enabling the system to prevent congestion, avoid congestion, promote traffic flow, enhance driver behavior, promote driver breaks or smart diversions etc.

Reference is now made to FIG. 2A, which illustrates an example of a vehicle sensor device 215 located on a street light or traffic light 210, thereby providing a vantage point to monitor vehicle flow/traffic in a selected area or range. In general, sensor device 215 is designed to sense vehicles or users with system registered vehicle controlled devices 110. In other embodiments sensor device 215 may be designed to sense vehicles or users without system registered vehicle controlled devices 110. Of course, other locations may be selected, in accordance with the sensor ranges, traffic monitoring, safety tracking requirements etc.

Reference is now made to FIG. 2B, which pictures an example of a radar sensor device 216 located on a pole 218, thereby providing a vantage point to monitor vehicle flow/traffic in a selected area. In the current example, the sensor device may be powered by a solar panel 220, however other energy sources may be used. In other embodiments, Internet applications or programs such as Waze, Google Traffic etc. may be used to provide traffic flow data. Of course, other locations may be selected, in accordance with the sensor ranges, traffic monitoring, safety tracking requirements etc. Further, other sensor types or combinations of sensors may be used, such as optic sensors, light sensors, heat sensors, data or signal sensors etc.

Reference is now made to FIGS. 2C-2E, which illustrate an example of early warning sensors, for example cellular or wireless sensor devices 215 and radar sensor device 216, preferably located on a pole, bridge, building etc. thereby providing a vantage point to monitor vehicle flow/traffic in a selected area. In the current example, sensor 215 may enable monitoring vehicles with system registered devices, while sensor 216 may monitor all vehicles, whether registered with the system or not. Data from sensors may be transmitted to computing or processing center 225 for processing and utilizing the sensed data and/or other data.

In some embodiments, sensor 216 may be located outside or beyond traffic control and management system 100, to enable data to be acquired, processed and utilized by computing center 225, preferably before vehicles enter traffic control and management system 100 zone, thereby enabling provision of early warnings, for example, to recommend to vehicles to change their routes or divert to a waiting station in order to help avoid and/or prevent congestion. For example, data from computing system may be transmitted to vehicles with registered devices, indicating preferred actions to be taken, if any. For example, instructions may be provided to vehicles 240 and 241 to take the next exit so as to be voluntarily diverted to a waiting station etc.

In accordance with an example of some embodiments, if a particular road has the capacity to handle 100 vehicles a minute and maintain a relatively fast flow, when 105 vehicles enter the road in a minute, a traffic jam will inevitably form, slowing down the traffic flow substantially. This of course will become seriously aggravated if more vehicles join the flow, if there are accidents, obstacles etc. In such a common scenarios, it would be advantageous to predict flow problems and prevent them happening or getting worse, by diverting excess traffic to transportation stations designed to service drivers in a fully synchronized manner so as to enable free flow management. For example, when a congestion scenario is determined, predicted or happens, drivers of excess vehicles (beyond the calculated optimal flow limit that a road can handle) are alerted, and are automatically diverted to one or more geographically positioned traffic control stations to prevent additional congestion pressure, while waiting for an optimal time to be instructed to rejoin the road to get to their destination. System 100 may incorporate prediction algorithms, traffic control algorithms and other logistic enhancing algorithms to help identify, verify and/or modify users' traffic behavior.

In some examples, the drivers may be encouraged to divert to the stations by offering points, special offers or other benefits, optionally customized in accordance with wait times logged, cooperation with system recommendations, driver activities during station stop-overs etc. In further examples, drivers may be penalized or fined for non conformance to system instructions or recommendations.

In further embodiments drivers in the network are typically kept informed of real time traffic conditions and arrival time predictions. In one example, drivers may program necessary times of arrival at their destinations, which the system will take into consideration when conducting traffic flow management. In the current example, if driver x and driver y both need to arrive at destination A, but their arrival times are 20 minutes apart, the system may direct driver x into the traffic flow without a diversion, yet may divert driver y for up to 20 minutes, optionally by offering benefits, in which case both driver x and driver y will be directed to arrive on time, yet allowing the traffic congestion to be lowered for both in accordance with the various drivers' real world needs.

In yet further embodiments traffic control or security authorities, including security forces, ambulances, fire brigades etc. may be able to access trouble spots, problems etc. by gaining system support to provide them the optimal access routes and flows to get to emergency locations. In such cases, the system may provide masses of vehicles with emergency instructions such as to pull over and wait on the side of a road, or at a selected traffic control destination or station to allow emergency services to achieve faster and safer operations, thereby solving traffic congestion causing factors faster and safer, for the benefit of all the road drivers.

In accordance with some embodiment vehicle drivers may be enabled to enter their diversion preferences on their vehicle control systems or applications, for example, whether they need gas, a car wash, coffee, shopping, recharging, sleep area, Internet browsing etc. In such cases, the system may direct drivers to relevant areas, and optionally specific parking places at required service areas, to provide drivers with efficient needed services while they wait for an optimal time to rejoin the traffic flow. In some embodiments drivers may be directed to “instant shopping” areas, for example, where they may be able to place orders and receive goods or services from their vehicles, and/or collect pre-ordered and substantially ready to take goods or services.

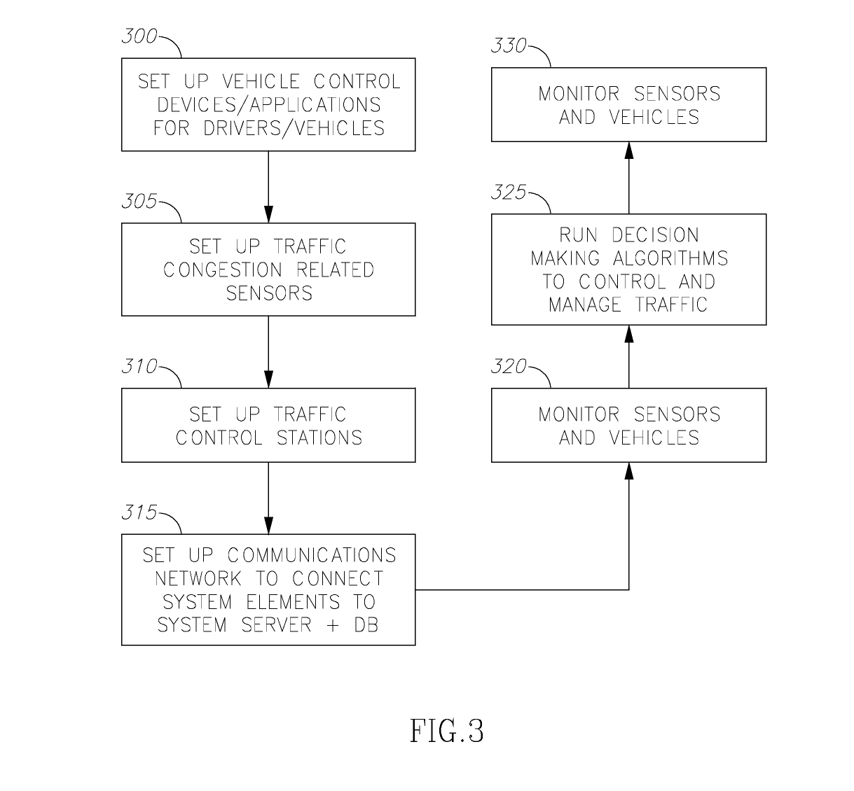

Reference is now made to FIG. 3, which is a flow diagram indicating the process by which traffic congestion is managed and controlled, using a Communications network 105 provided to service vehicle control devices 110, according to some embodiments. The process, in some embodiments, includes running one or more files with instructions to execute commands to enable managing and controlling of traffic flow in a traffic management system. As can be seen in the figure, at block 300, multiple users and/or vehicles are supplied with vehicle control devices and/or applications, integrating positioning technology such as GPS. At block 305, traffic, environment and/or road sensors are set up at multiple locations to as to provide substantially real time feedback on road and traffic conditions and predictions. At block 310 traffic control stations are set up, to include stopping/resting/recreation facilities/locations and optionally product/service businesses to be supplied to vehicles entering these stations. In block 315 a communication network is set up to connect the respective stations, vehicle devices, sensors, and communications networks, to operate in communication with a central, cloud based and/or distributed server(s) system and system database(s). At block 320, once the system has been activated, vehicle positions of system users may be monitored, as may be roads, environmental factors etc. At block 325 decision making processes or queries may be run for all elements in the system, including vehicles, roads, stations, sensors etc., to generate substantially real time decisions relating to action to be taken by system users to enhance traffic flow and/or prevent traffic congestion. In some embodiments traffic authorities, security officials, emergency services etc. may be hooked into the system decision making hierarchy, to enable optimal mobilization and location access according to the need. At block 330, drivers of vehicles being monitored by the system may be diverted, aided, provided with a variety of services etc., to enable optimal traffic congestion control and management. Of course, other services may be provided to drivers, users, service providers, authorities etc., as may be needed.

According to certain embodiments, the traffic congestion management process may include location specific transportation stations or hubs which are adapted to provide benefits and services for drivers, and further to enable preventing, reducing or limiting no-waiting time or congestion, by using updated and precise park and time prediction etc.

According to some embodiments, users with flexible time schedules may be pro-actively informed or notified when to start their journey, when to leave their home or current location etc., in accordance with optimized traffic conditions. For example, users may pre-program a general or specific schedule to include tasks, appointments, things to do etc., and the level of importance and/or flexibility of such items. The system may subsequently pro-actively alert the user when to start a journey, which route to take, where to stop along the way, what else may be done along the way, such as stopping for gas, coffee, shopping, entertainment etc. Such information may be provided to a user on a per-user customized level, for example, when a user is on a journey, when a user is at a control station or location, and/or pro-actively before a journey has begun.

According to some embodiments, drivers or users may enter personal preferences into the system, such as daily/weekly/monthly schedules, destination time arrival requests, etc., according to which the system may provide optimized driving routes, instructions etc.

According to some embodiments, every driver/user may identify her/himself with a unique login and password that is not necessarily connected to her/his real identity. In such cases, data about such a driver's location, preferences, history etc., as well as special codes, personal coupons etc. may be associated substantially with an anonymous user account, to protect users' identities.

According to some embodiments, a jurisdiction such as a municipality, government, traffic authority or private concern etc., may be able to provide benefits to users who conform with system instructions and requests. On the other hand, jurisdictions may be able to provide fines or sanctions against users who do not conform with system instructions and requests. Surveillance cameras, sensors or other means may be used to monitor user behavior for the above described purposes.

According to some embodiments, a bridge or other structure may be used to connect the rest station to the public road(s), such that this connection channel may be monitored to manage traffic in both directions, to handle traffic congestion in for example the morning on a first direction and in the evening in a second direction.

According to some embodiments, a user purchase of a local product via the Internet may be redirected to be available to a purchaser at a rest area or station. Product tracking technology may enable such a client to know about his/her order and its location to facilitate such a process.

According to some embodiments, after a user purchase has been prepared based on a pre-order, the user may receive a message, such as an IM, SMS, application alert or email to inform him/her about this. Such a notification system may use, for example, bar codes or Rf-ID etc. Further, the user may optionally receive status updates as the order is received, accepted, handled, prepared, and ready etc.

According to some embodiments, a pre-programmed or ordered/booked parking arrangement in a rest area or alternative parking spot may be used to arrange for automated delivery of a purchase to the user's vehicle (even into the user's trunk etc.).

According to some embodiments, the client may need to be identified to receive an order. Identification may be executed by the user entering a unique identifying code on the delivery agent's computing device (e.g., a waiter's tablet, smartphone or handheld computer. In some cases the purchaser may receive the code (permanent or changing code) by SMS, email, mail, in the Smartphone application, or using Near Field Communication (NFC) technology etc.

It will be apparent that the invention or its embodiments as described herein may be implemented in any combination of software or hardware as appropriate, and may use any suitable code or algorithms as appropriate.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for facilitating traffic congestion control, comprising:
traffic related sensors;
vehicle control devices; and
a system server and database, adapted to receive traffic information from the traffic related sensors and run traffic control decision making algorithms to generate substantially real time traffic control decisions in accordance with the traffic information, wherein said server includes a file with instructions to execute commands to enable execution of said traffic control decisions,
wherein the system is operable to receive input information from the vehicle control devices and transmit output information to the vehicle control devices in accordance with the traffic control decisions.

2. The system of claim 1 wherein the output information comprises one or more of; congestion warning information, congestion prevention information, route change information, and journey timing information.

3. The system of claim 1, where said database includes a memory having stored thereon user preference data, participating vehicle data, sensor data and traffic control station data.

4. The system of claim 1 wherein the input information comprises driver journey preference information from a vehicle control device, and the system transmits output information to the vehicle control device in accordance with the traffic control decisions and the driver journey preference information.

5. The system of claim 4 wherein the output information comprises one or more of; congestion warning information, congestion prevention information, route change information, and journey timing information.

6. The system of claim 1, further comprising one or more traffic control stations, wherein the output information comprises directions to exit to a traffic control station and to wait there for a specified time.

7. The system of claim 6 wherein, when the vehicle is at a station, the output information comprises guidance to a specific station area.

8. The system of claim 1 wherein the input information comprises one or more of; vehicle speed, vehicle location, driver route preference information, driver rest stop preference information, and driver journey preference information.

9. A vehicle control device, comprising code operable to receive driver journey preference information, transmit said driver journey preference information to a traffic congestion control system, receive output information from the traffic congestion control system, and provide said output information to a driver.

10. The vehicle control device of claim 9 wherein the output information comprises one or more of; congestion warning information, congestion prevention information, route change information, journey timing information, and directions to exit to a traffic control station and to wait there for a specified time.

11. The vehicle control device of claim 9 operable to receive request information and enable efficient access of service and/or product in accordance with the request information.

12. The vehicle control device of claim 9 further operable to transmit input information to the traffic congestion control system,—wherein the input information comprises one or more of; vehicle speed, vehicle location, driver rest stop preference information, driver journey preference information and driver route preference information

13. A system for advanced traffic management, comprising a communications network adapted to facilitate substantially real time communication between multiple traffic system components, to enable traffic congestion prevention, where said communications network includes a system server including instructions to execute commands to enable traffic decision making algorithms to optimize traffic congestion prevention, and where said system server includes instructions to execute commands to enable user driven requests to be processed, and users to be automatically channeled to traffic control locations.

14. The system of claim 13, wherein said automated channeling is adapted to enable efficient access of service and/or product requests.

15. The system of claim 13, where said communications network includes a database component, including a memory having stored thereon user preference data, participating vehicle data, sensor data and traffic control station data.

16-17. (canceled)
